(19) United States
(12) Patent Application Publication
(10) Pub. No.: US 2010/0317313 A1
(43) Pub. Date: Dec. 16, 2010

(54) DUAL-BAND COUPLER UNIT AND DUAL-BAND COUPLER THEREOF AND RECEIVER THEREOF

(75) Inventors: Jen-Tsai Kuo, Hsinchu City (TW); Yi-Chyun Chiou, Hsinchu City (TW); Chi-Hung Chan, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NATIONAL CHIAO TUNG UNIVERSITY, Hsinchu City (TW)

(21) Appl. No.: 12/683,416

(22) Filed: Jan. 6, 2010

(30) Foreign Application Priority Data
Jun. 10, 2009 (TW) 98119444

(51) Int. Cl. H04B 1/16; H01P 5/00

(52) U.S. Cl. 455/338; 333/27

(57) ABSTRACT

A dual-band coupler unit is provided. The dual-band coupler unit includes a first coupled line, a second coupled line, a short transmission line, a first transmission line, and a second transmission line. The first coupled line and the second coupled line are substantially in parallel with each other, and are substantially of the same length. One end of the short transmission line is connected to one end of the first coupled line, and the other end of the short transmission line is connected to one end of the second coupled line. One end of the first transmission line is connected to the other end of the first coupled line, and one end of the second transmission line is connected to the other end of the second coupled line.

### CROSS-REFERENCE TO RELATED APPLICATION

This application claims the priority benefit of Taiwan application serial no. 98119444, filed on Jun. 10, 2009. The entirety of the above-mentioned patent application is hereby incorporated by reference herein and made a part of specification.

### BACKGROUND OF THE INVENTION

1. Field of the Invention

The present invention generally relates to a coupler, in particular, to a dual-band coupler unit, a dual-band coupler thereof, and a receiver thereof.

2. Description of Related Art

With the development of communication technologies, currently, many computers and handheld devices are connected to the Internet through wireless communication technologies. Generally, a receiver for wireless communication needs to have a coupler for coupling a signal received by an antenna and transmitting the received signal to a communication chip in the receiver through a transmission line. In addition, as electronic products develop towards light, thin, short, small and power-saving ones, smaller couplers cater to the development trend of electronic products in a better way, and even may lower the manufacturing cost.

With reference to U.S. Pat. No. 5,382,925, a single-band hybrid coupler with a multi-layer structure was proposed by Hayashi et al. Although the area of such a single-band hybrid coupler is somewhat reduced, a multi-layer structure must be used, so that the reduction in the manufacturing cost and area is limited. In addition, the coupler proposed by Hayashi et al. is a single-band coupler, and can only be operated in a specific frequency band.

Then, with reference to U.S. Pat. No. 6,756,860 B2, a dual-band coupler with a multi-layer structure was proposed by Shin. In the dual-band coupler, an operating frequency of a second frequency band is controlled by using a coupling coefficient provided by a dielectric layer, thus coupling signals at two different frequencies of the first and second frequency bands. However, as the dual-band coupler has a multi-layer structure, the reduction in the manufacturing cost and area is also limited.

With reference to a paper published by Cheng et al. on IEEEE in November, 2004, entitled “A novel approach to the design and implementation of dual-band compact planar 90° branch-line coupler” and a paper published by Hsu et al. in June, 2007, entitled “Design of dual-band microstrip rat race coupler with circuit miniaturization”, dual-band couplers designed by adopting an uniform transmission line and a stepped-impedance transmission line were proposed by Cheng and Hsu et al., respectively. However, the reduction of the dual-band couplers in terms of area is still not so desirable, and further improvement can be made.

### SUMMARY OF THE INVENTION

The present invention provides a dual-band coupler unit. The dual-band coupler unit includes a first coupled line, a second coupled line, a short transmission line, a first transmission line, and a second transmission line. The first coupled line and the second coupled line are substantially in parallel with each other, and are substantially of the same length. One end of the short transmission line is connected to one end of the first coupled line, and the other end of the short transmission line is connected to one end of the second coupled line. One end of the first transmission line is connected to the other end of the first coupled line, and one end of the second transmission line is connected to the other end of the second coupled line.

In an embodiment of the present invention, the first transmission line and the second transmission line are uniform transmission lines or non-uniform transmission lines.

The present invention further provides a dual-band coupler, which includes a plurality of dual-band coupler units and at least four ports. Each dual-band coupler unit includes a first coupled line, a second coupled line, a short transmission line, a first transmission line, and a second transmission line. The first coupled line and the second coupled line are substantially in parallel with each other, and are substantially of the same length. One end of the short transmission line is connected to one end of the first coupled line, and the other end of the short transmission line is connected to one end of the second coupled line. One end of the first transmission line is connected to the other end of the first coupled line, and one end of the second transmission line is connected to the other end of the second coupled line. The first transmission line of each dual-band coupler unit is connected to the second transmission line of another dual-band coupler unit, and the four ports are connected to the first transmission lines of four dual-band coupler units.

In an embodiment of the present invention, wherein the dual-band coupler has a circular layout, and the number of the dual-band coupler units is six.

The present invention further provides a receiver, which includes a receiving chip. A dual-band coupler is disposed in the receiving chip, and the dual-band coupler includes a plurality of dual-band coupler units and at least four ports. Each dual-band coupler unit includes a first coupled line, a second coupled line, a short transmission line, a first transmission line, and a second transmission line. The first coupled line and the second coupled line are substantially in parallel with each other, and are substantially of the same length. One end of the short transmission line is connected to one end of the first coupled line, and the other end of the short transmission line is connected to one end of the second coupled line. One end of the first transmission line is connected to the other end of the first coupled line, and one end of the second transmission line is connected to the other end of the second coupled line. The first transmission line of each dual-band coupler unit is connected to the second transmission line of another dual-band coupler unit, and the four ports are connected to the first transmission lines of four dual-band coupler units.

In view of the above description, the dual-band coupler unit and the dual-band coupler thereof provided by the present invention couple signals in two different frequency bands at the same time, and both have a small size that can be easily integrated in a communication chip, thus achieving a miniaturized circuit. In addition, the operating frequency of the second frequency band of the dual-band coupler unit or the dual-band coupler thereof can be changed by adjusting structural parameters of the dual-band coupler unit and the dual-band coupler thereof.

In order to make the aforementioned and other features and advantages of the present invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structural view of a dual-band coupler unit 100 according to an embodiment of the present invention.

FIG. 2 is a schematic structural view of a dual-band coupler 200 according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

The dual-band coupler unit and the dual-band coupler using the same provided by the present invention are further described in detail below through embodiments and the accompanying drawings; however, the embodiments are merely exemplary, and are not intended to limit the present invention.

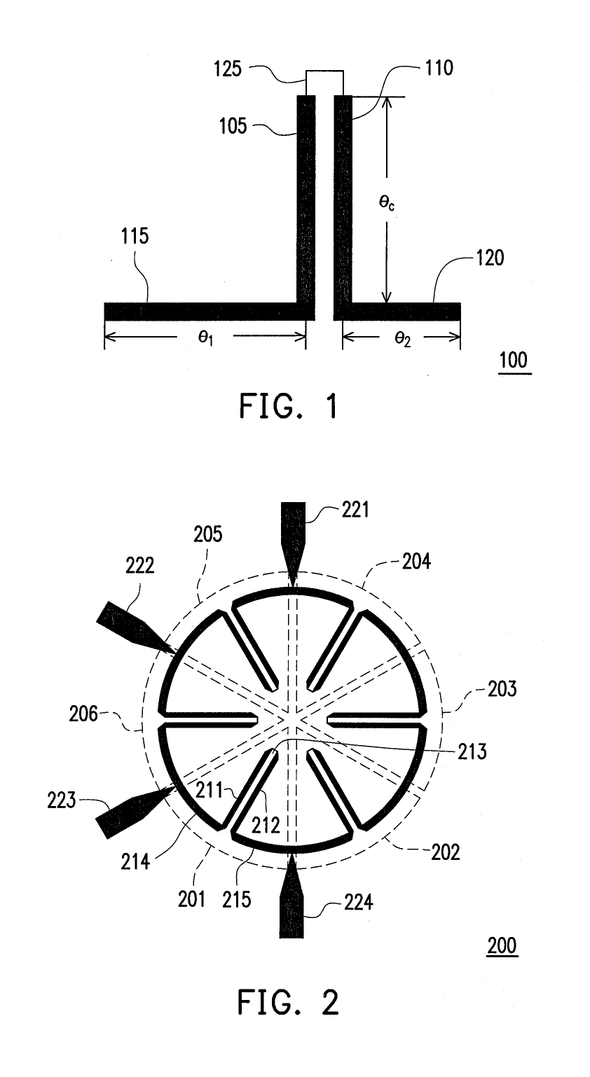

FIG. 1 is schematic structural view of a dual-band coupler unit 100 according to an embodiment of the present invention. Referring to FIG. 1, the dual-band coupler unit 100 includes coupled lines 105 and 110, a short transmission line 125, and transmission lines 115 and 120. One end of the short transmission line 125 is connected to one end of the coupled line 105, and the other end of the short transmission line 125 is connected to one end of the coupled line 110. One end of the transmission line 115 is connected to the other end of the coupled line 105, and one end of the transmission line 120 is connected to the other end of the coupled line 110.

In this embodiment, the coupled lines 105 and 110 are substantially in parallel with each other, and of the same length θ_{C}. In this embodiment, the transmission lines 115 and 120 are straight transmission lines; however, the transmission lines 115 and 120 may also be curve transmission lines. The transmission lines 115 and 120 are substantially perpendicular to the coupled lines 105 and 110, that is to say, an angle formed between the transmission line 115 and the coupled line 105 is substantially 90 degrees, and an angle formed between the transmission line 120 and the coupled line 110 is substantially 90 degrees. However, the angles formed between the transmission lines 115 and 120 and the coupled lines 105 and 100 are not limited to 90 degrees.

In addition, the coupled line 105 and the coupled line 110 may be uniform coupled lines or non-uniform coupled lines. The transmission line 115 may be a uniform transmission line or a non-uniform transmission line, and likewise, the transmission line 120 may also be a uniform transmission line or a non-uniform transmission line. In addition, in this embodiment, lengths of the transmission lines 115 and 120 are θ₁ and θ₂, respectively. An operating frequency of a second frequency band of the dual-band coupler unit 100 may be adjusted by adjusting structural parameters of the transmission lines 115 and 120, i.e., the lengths θ₁ and θ₂, in which the operating frequency of the second frequency band is n times of an operating frequency of a first frequency band, and n is any positive integer or any positive number. In addition, a phase difference between signals in the dual-band coupler unit 100 may also be adjusted by adjusting structural parameters of the transmission lines 115 and 120 and the coupled lines 105 and 110, i.e., the lengths θ₁, θ₂, and θ_{c}. In such a manner, the dual-band coupler unit 100 may be construed as a phase shifter.

It should be noted that as the dual-band coupler unit 100 is merely constituted by the coupled lines 105 and 110, the short transmission line 125, and the transmission lines 115 and 120, the dual-band coupler unit 100 may be a dual-band coupler unit with a single layer structure, and thus the area can be greatly reduced. In addition, as the area is greatly reduced, the dual-band coupler unit 100 can be integrated in a semiconductor chip, a planar printed circuit element, or a multi-layer circuit element more easily.

The operating frequency of the first frequency band of the dual-band coupler unit 100 may be designed around 2.4 GHz, and the operating frequency of the second frequency band thereof may be designed around 5.8 GHz. In such a manner, the dual-band coupler unit 100 may be further applied in a communication transceiver for IEEE 802.11a/b/g and other protocols. Definitely, the above application is not intended to limit the present invention. As long as the frequency of the first frequency band of the dual-band coupler unit 100 is selected, impedances of the coupled lines 105 and 110 can be determined based on a curve relation between the impedances thereof and the lengths θ₁ and θ₂ of the transmission lines 115 and 120, thus determining the length θ_{C} of the coupled lines 105 and 110.

FIG. 2 is a schematic structural view of a dual-band coupler 200 according to an embodiment of the present invention. Referring to FIG. 2, the dual-band coupler 200 includes a plurality of dual-band coupler units 201-206 similar to FIG. 1, and four ports. Structures and connection relations of the dual-band coupler units 201-206 are described by taking the dual-band coupler unit 201 as an example. It is apparent to those of ordinary skill in the art, although the description is merely given by taking the dual-band coupler unit 201 as an example, the structures and connection relations of the dual-band coupler units 202-206 may be deduced by analogy.

Referring to FIG. 2, parallel coupled lines 211 and 212 are disposed in the middle of the dual-band coupler unit 201. The coupled lines 211 and 212 are connected to each other by a short transmission line 213, and then connected to transmission lines 214 and 215, respectively. In addition, the transmission lines 214 and 215 of the dual-band coupler unit 201 are further connected to transmission lines of the dual-band coupler units 202 and 206, respectively. Ports 221-224 are connected to the transmission lines of the dual-band coupler units 205, 206, 201, and 202, and are used to receive signals from the transmission lines or transmit signals to the transmission lines.

The difference between the dual-band coupler unit 201 and the dual-band coupler unit 100 of FIG. 1 lies in that, the transmission lines 214 and 215 are curve transmission lines, rather than straight transmission lines. Therefore, in FIG. 2, the dual-band coupler units 201-206 are circularly laid out to form the dual-band coupler 200. In addition, in this embodiment, a total length of all the transmission lines may be 6/4 times of a wavelength of the first frequency band of the corresponding dual-band coupler 200. However, it should be noted that the present invention is not limited to this. The dual-band coupler may be also formed by laying out a plurality of dual-band coupler units as different closed curves.

In addition, the dual-band coupler 200 may also be applied in a communication transceiver for IEEE 802.11a/b/g and other protocols, for example, disposed in a receiving chip of the receiver to serve as a dual-band coupler of the receiver. Definitely, the above application is not intended to limit the present invention, and the dual-band coupler 200 may also be applied in transceivers for different frequency bands and protocol standards by adjusting the operating frequencies of the first frequency and the second frequency bands thereof.

To sum up, the dual-band coupler unit and the dual-band coupler thereof provided by the present invention may couple signals in two different frequency bands at the same time, and both have a small size that can be easily integrated in a communication chip, thus achieving a miniaturized circuit. In addition, operating frequencies of second frequency bands of the dual-band coupler unit and the dual-band coupler thereof may be changed by adjusting structural parameters of the dual-band coupler unit and the dual-band coupler thereof.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A dual-band coupler unit, comprising:
a first coupled line and a second coupled line, substantially in parallel with each other, and substantially of the same length;
a short transmission line, comprising one end connected to one end of the first coupled line, and the other end connected to one end of the second coupled line; and
a first transmission line and a second transmission line, wherein one end of the first transmission line is connected to the other end of the first coupled line, and one end of the second transmission line is connected to the other end of the second coupled line.

2. The dual-band coupler unit according to claim 1, wherein the first transmission line and the second transmission line are substantially perpendicular to the first coupled line and the second coupled line.

3. The dual-band coupler unit according to claim 1, wherein the first coupled line and the second coupled line are uniform coupled lines or non-uniform coupled lines, or one is a uniform coupled line, and the other is a non-uniform coupled line.

4. The dual-band coupler unit according to claim 1, wherein the first transmission line and the second transmission line are uniform transmission lines or non-uniform transmission lines, or one is a uniform transmission line, and the other is a non-uniform transmission line.

5. The dual-band coupler unit according to claim 1, wherein the dual-band coupler unit is a dual-band coupler unit with a single layer structure.

6. The dual-band coupler unit according to claim 1, wherein operating frequencies of a first frequency band and a second frequency band of the dual-band coupler unit are approximately 2.4 GHz and 5.8 GHz, respectively.

7. The dual-band coupler unit according to claim 1, wherein an operating frequency of a second frequency band of the dual-band coupler unit is adjusted by changing structural parameters of the first transmission line and the second transmission line.

8. The dual-band coupler unit according to claim 1, wherein a phase difference between signals transmitted by the dual-band coupler unit is adjusted by changing structural parameters of the first transmission line, the second transmission line, the first coupled line, and the second coupled line.

9. A dual-band coupler, comprising a plurality of dual-band coupler units and at least four ports, wherein each dual-band coupler unit comprises:
a first coupled line and a second coupled line, substantially in parallel with each other, and substantially of the same length;
a short transmission line, comprising one end connected to one end of the first coupled line, and the other end connected to one end of the second coupled line; and
a first transmission line and a second transmission line, wherein one end of the first transmission line is connected to the other end of the first coupled line, and one end of the second transmission line is connected to the other end of the second coupled line;
wherein the first transmission line of each dual-band coupler unit is connected to the second transmission line of another dual-band coupler unit, and the ports are connected to the first transmission lines of the dual-band coupler units.

10. The dual-band coupler according to claim 9, wherein the dual-band coupler has a circular layout, and the number of the dual-band coupler units is six.

11. The dual-band coupler according to claim 9, wherein the first transmission line and the second transmission line are substantially perpendicular to the first coupled line and the second coupled line.

12. The dual-band coupler according to claim 9, wherein the first coupled line and the second coupled line are uniform coupled lines or non-uniform coupled lines, or one is a uniform coupled line, and the other is a non-uniform coupled line.

13. The dual-band coupler according to claim 9, wherein the first transmission line and the second transmission line are uniform transmission lines or non-uniform transmission lines, or one is a uniform transmission line, and the other is a non-uniform transmission line.

14. The dual-band coupler according to claim 9, wherein the dual-band coupler unit is a dual-band coupler unit with a single layer structure.

15. The dual-band coupler according to claim 9, wherein operating frequencies of a first frequency band and a second frequency band of the dual-band coupler are approximately 2.4 GHz and 5.8 GHz, respectively.

16. The dual-band coupler according to claim 9, wherein an operating frequency of a second frequency band of the dual-band coupler is adjusted by changing structural parameters of the first transmission line and the second transmission line.

17. The dual-band coupler according to claim 9, wherein a phase difference between signals transmitted by the first transmission line and the second transmission line is adjusted by changing structural parameters of the first transmission line and the second transmission line.

18. A receiver, comprising a receiving chip, wherein a dual-band coupler is disposed in the receiving chip, the dual-band coupler comprises a plurality of dual-band coupler units and at least four ports, and each dual-band coupler unit comprises:
a first coupled line and a second coupled line, substantially in parallel with each other, and substantially of the same length;
a short transmission line, comprising one end connected to one end of the first coupled line, and the other end connected to one end of the second coupled line; and
a first transmission line and a second transmission line, wherein one end of the first transmission line is connected to the other end of the first coupled line, and one end of the second transmission line is connected to the other end of the second coupled line;
wherein the first transmission line of each dual-band coupler unit is connected to the second transmission line of another dual-band coupler unit, and the ports are connected to the first transmission lines of the dual-band coupler units.

19. The receiver according to claim 18, wherein the dual-band coupler has a circular layout, and the number of the dual-band coupler units is six.

20. The receiver according to claim 18, wherein the first coupled line and the second coupled line are uniform coupled lines or non-uniform coupled lines, or one is a uniform coupled line, and the other is a non-uniform coupled line.

21. The receiver according to claim 18, wherein the first transmission line and the second transmission line are uniform transmission lines or non-uniform transmission lines, or one is a uniform transmission line, and the other is a non-uniform transmission line.

22. The receiver according to claim 18, wherein the dual-band coupler unit is a dual-band coupler unit with a single layer structure.

23. The receiver according to claim 18, wherein operating frequencies of a first frequency band and a second frequency band of the dual-band coupler are approximately 2.4 GHz and 5.8 GHz, respectively.

24. The receiver according to claim 18, wherein an operating frequency of a second frequency band of the dual-band coupler is adjusted by changing structural parameters of the first transmission line and the second transmission line.

25. The receiver according to claim 18, wherein a phase difference between signals transmitted by the first transmission line and the second transmission line is adjusted by changing structural parameters of the first transmission line and the second transmission line.
